(19) United States
(12) Patent Application Publication
(10) Pub. No.: US 2008/0053970 A1
(43) Pub. Date: Mar. 6, 2008

(54) Soldering method and laser soldering apparatus

(75) Inventor: Kazuo Nakamae, Yokohama-shi (JP)

Correspondence Address: MCDERMOTT WILL & EMERY LLP, 600 13TH STREET, N.W., WASHINGTON, DC, 20005-3096, US

(73) Assignee: SUMITOMO ELECTRIC INDUSTRIES LTD.

(21) Appl. No.: 11/878,679

(22) Filed: Jul. 26, 2007

(30) Foreign Application Priority Data
Aug. 30, 2006 (JP) P2006-234322

(51) Int. Cl. B23K 26/00

(52) U.S. Cl. 219/121.61

(57) ABSTRACT

The present invention relates to a soldering method and the like comprising a structure for making it possible to solder microsize objects to each other. The soldering method is a method realizing the soldering by using a fiber laser apparatus capable of minutely adjusting the spot size of outputted laser light, and prepares the fiber laser apparatus and a spatial optical system before soldering the objects. The fiber laser apparatus includes an amplification optical fiber having a single core structure and outputting amplified single-mode light, and a seed light source supplying seed light to the amplification optical fiber. The spatial optical system includes a collimator collimating the outputted laser light from the fiber laser apparatus, and a condenser lens converging the outputted laser light transmitted through the collimator to solder which is set. Light having a pulse width of not shorter than a microsecond or continuous light outputted as outputted laser light from the fiber laser apparatus is applied to the solder set between objects to be soldered through the spatial optical system.

### BACKGROUND OF THE INVENTION

1. Field of the Invention

The present invention relates to a method and apparatus for performing soldering by irradiating solder or an object to be soldered with laser light.

2. Related Background Art

A technique which performs soldering by irradiating solder set between objects with laser light is disclosed in Japanese Patent Application Laid-Open No. HEI 6-77638 (Patent Document 1), for example. The soldering technique, disclosed in Patent Document 1, guides laser light outputted from a laser light source with an optical fiber, irradiates solder set between objects with the laser light outputted from the leading end of the optical fiber, and thereby performs soldering.

### SUMMARY OF THE INVENTION

The inventors have studied the prior art described above in detail, and as a result, have found problems as follows.

Namely, the prior art performing soldering by laser light irradiation cannot sufficiently reduce the spot size of laser light when converging the laser light to a soldering location. It is therefore difficult for the prior art to solder microsize electronic devices and the like arranged in a length of 0.1 mm or less, for example. In particular, needs for soldering techniques in minute areas have recently been increasing as electronic devices have become smaller.

In order to overcome the above-mentioned problems, it is an object of the present invention to provide a soldering method and apparatus of enabling the soldering in minute areas.

A soldering method according to the present invention is a method which realizes the soldering by using a fiber laser apparatus capable of minutely adjusting the spot size of outputted laser light, and performs the soldering between objects by using the fiber laser apparatus and a spatial optical system. In particular, the soldering method prepares a fiber laser apparatus, prepares a spatial optical system, controls a seed light source included in the fiber laser apparatus so as to yield desirable outputted laser light, and irradiates solder set between objects with thus obtained outputted laser light.

The fiber laser apparatus to be prepared includes an optical fiber which has a single core structure and which outputs single-mode light, and a seed light source for supplying seed light to the optical fiber. In the specification, the wording “single core structure” includes the structure that only one or more core regions are concentrically arranged like a dual core, but does not include a multi-core structure such that a plurality of core regions are dotted within a central region of an optical fiber. The spatial optical system prepared includes a collimator collimating the outputted laser light from the fiber laser apparatus, and a condenser lens converging the outputted laser light transmitted through the collimator. The seed light source included in the fiber laser apparatus is controlled such that light having a pulse width of not shorter than a microsecond or continuous light is outputted as the outputted laser light from the fiber laser apparatus. By way of the spatial optical system, the outputted laser light from the fiber laser apparatus, which is obtained by controlling the seed light source as mentioned above, is applied to the solder set between the objects.

Preferably, in the soldering method according to the present invention, the objects to be soldered are heated before irradiating the solder set between the objects with laser light. In particular, the objects are initially heated by irradiation with the outputted laser light from the fiber laser apparatus converged by the spatial optical system. Thereafter (after the objects are heated), the outputted laser light from the fiber laser apparatus, which is converged by the spatial optical system, is applied to the solder set between the objects, whereby the objects can be soldered more efficiently to each other. Namely, peripheral areas of the soldering part can be prevented from being heated unnecessarily.

The soldering method according to the present invention may comprise the step of removing an unnecessary solder part after soldering the objects. Namely, after soldering the objects, an unnecessary solder part generated at the time of soldering the objects is irradiated with light having a pulse width of a nanosecond or less outputted from one selected from the fiber laser apparatus and another fiber laser apparatus irradiates by way of the spatial optical system, whereby the unnecessary solder part can be removed.

In the soldering method according to the present invention, the spatial optical system is adjusted so as to converge the outputted laser light from the fiber laser apparatus such that the spot size of the outputted laser light, applied to the solder from the fiber laser apparatus, falls within the range of 1 μm to 100 μm.

In the soldering method according to the present invention, it is preferable that the optical fiber includes a Yb-doped optical fiber, whereas the fiber laser apparatus includes a wavelength conversion device for converting the wavelength of the output light from the optical fiber. In this case, the light whose wavelength is converted to 532 nm by the wavelength conversion device irradiates the solder by way of the spatial optical system.

In the soldering method according to the present invention, the seed light source preferably includes a semiconductor laser, whereas the fiber laser apparatus has an oscillation adjustment mechanism adjusting an oscillation condition of the semiconductor laser as a MOPA-type laser apparatus.

The soldering method according to the present invention may comprise a step of protecting a soldering part in the objects. Namely, before soldering the objects, one of the objects is bonded to a surface of a plastic sheet with an adhesive. Thereafter, in the state where the one object bonded to the plastic sheet is soldered with the other object, the objects are soldered to each other. As another protecting means, respective soldering parts in the objects are covered with a plastic sheet after soldering the objects. Thereafter, as the outputted laser light from the fiber laser apparatus, light having a pulse width of not shorter than a microsecond or continuous light irradiates the plastic sheet by way of the spatial optical system, thereby forming a plastic protective film in the soldering parts.

A laser soldering apparatus according to the present invention irradiates solder set between objects with laser light, thereby soldering the objects. In particular, the laser soldering apparatus comprises a fiber laser apparatus and a spatial optical system, whereas the fiber laser apparatus outputs light having a pulse width of not shorter than a microsecond or continuous light as output light.

The fiber laser apparatus is one outputting single-mode light as outputted laser light, and includes an optical fiber, a seed light source, and an oscillation adjustment mechanism. The optical fiber includes an amplification optical fiber having a single core structure and outputting amplified single-mode light, for example. The seed light source supplies seed light to the optical fiber. The oscillation adjustment mechanism enables both continuous and pulsed oscillations in the optical fiber.

On the other hand, the spatial optical system includes a collimator collimating the outputted laser light from the fiber laser apparatus, and a condenser lens converging the outputted laser light having transmitted through the collimator.

In the laser soldering apparatus according to the present invention, the oscillation adjustment mechanism preferably comprises a structure for enabling an oscillation of a nanosecond pulse in the optical fiber. Also, it is preferable that the fiber laser apparatus has a pulse width adjustment mechanism for adjusting the pulse width of the outputted laser light in order to regulate an oscillation condition in the optical fiber.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1A is a view for explaining an initial step of the soldering method according to the present invention while showing the structure of an embodiment of the laser soldering apparatus according to the present invention, whereas FIG. 1B is a plan view specifically showing an arrangement of objects to be soldered;

FIG. 2 is a view for explaining an intermediate step of the soldering method according to the present invention while showing the structure of an embodiment of the laser soldering apparatus according to the present invention;

FIG. 3 is a view for explaining the final step of the soldering method according to the present invention while showing the structure of an embodiment of the laser soldering apparatus according to the present invention;

FIG. 4 is a view showing the structure of a fiber laser apparatus employed in the laser soldering apparatus according to the present invention;

FIG. 5 is a view showing another structure of a fiber laser apparatus employed in the laser soldering apparatus according to the present invention; and

FIG. 6 is a graph showing the wavelength dependency of absorption ratio of Sn.

### DETAILED DESCRIPTION OF THE PREFERRED EMBODIMENTS

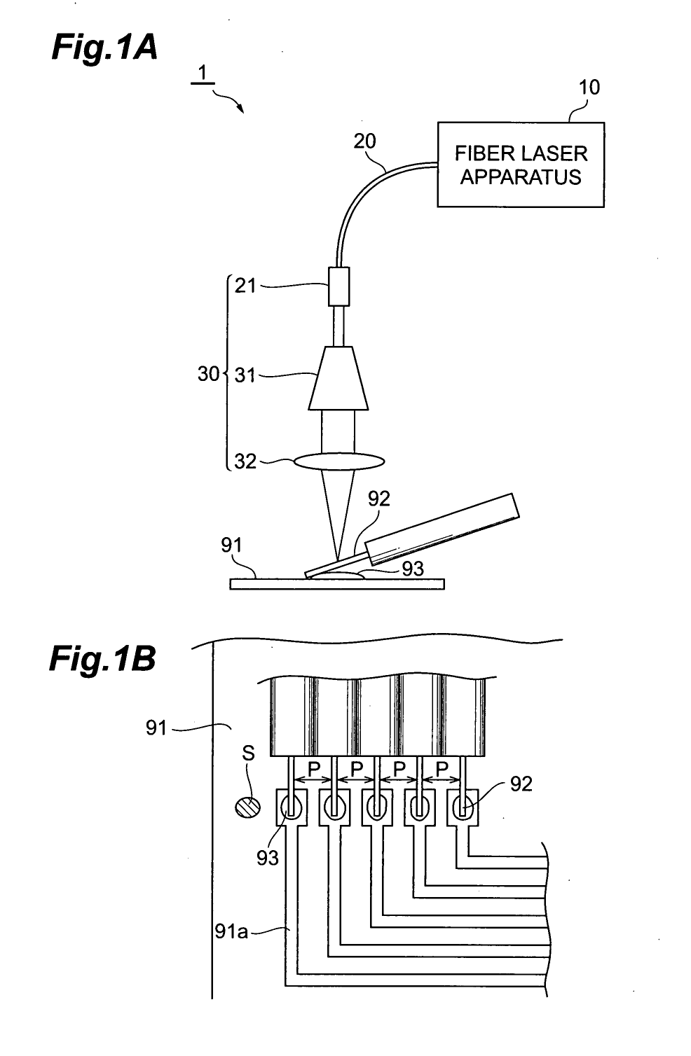

In the following, embodiments of the soldering method and laser soldering according to the present invention will be explained in detail with reference to FIGS. 1A, 1B, and 2 to 6. In the explanation of the drawings, constituents identical to each other will be referred to with numerals identical to each other without repeating their overlapping descriptions.

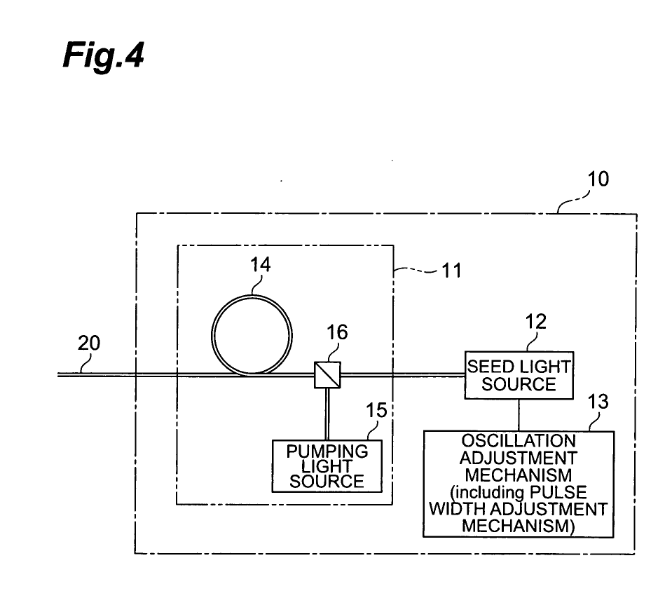

FIGS. 1A, 2, and 3 are views for sequentially explaining the steps of the soldering method according to the present invention while showing the structure of an embodiment of the laser soldering apparatus according to the present invention. FIG. 4 is a view showing the structure of a fiber laser apparatus employable in the laser soldering apparatus according to the present invention. FIGS. 1A, 2, and 3 show not only a laser soldering apparatus 1, but also a substrate 91 and coaxial cable center conductors 92 which are objects to be soldered, and solder 93 and a plastic 94.

The laser soldering apparatus 1 comprises a fiber laser apparatus 10, a guide optical fiber 20, and a spatial optical system 30. The spatial optical system 30 includes a collimator 21, a beam expander 31, and a condenser lens 32. As shown in FIG. 4, the fiber laser apparatus 10 comprises an optical amplifier 11, a seed light source 12, and an oscillation adjustment mechanism 13. The optical amplifier 11 includes an amplification optical fiber 14, a pumping light source 15, and an optical coupler 16.

The amplification optical fiber 14 is an optical device having a single core structure and outputting amplified light as single-mode light, an example of which is a Yb-doped optical fiber amplifying light having a wavelength of 1064 nm. The pumping light source 15 is an optical device outputting pumping light to be supplied to the amplification optical fiber 14, and includes a semiconductor laser device, for example. The seed light source 12 is an optical device outputting seed light to be amplified in the amplification optical fiber 14, and includes a semiconductor laser device, for example. The oscillation adjustment mechanism 13 drives the seed light source 12, so as to enable both continuous and pulsed oscillations, and adjusts the pulse width in the case of pulsed oscillation (functions as a pulse width adjustment mechanism).

The pumping light outputted from the pumping light source 15 is supplied to the amplification optical fiber 14 through the optical coupler 16. The supplied pumping light pumps elemental Yb contained in the amplification optical fiber 14. The seed light source 12 driven by the oscillation adjustment mechanism 13 outputs seed light. The seed light is fed into the amplification optical fiber 14 through the optical coupler 16, and is amplified in the amplification optical fiber 14. Namely, the fiber laser apparatus 10 has a MOPA (Master Oscillator Power Amplifier) structure. The light amplified in the amplification optical fiber 14 is outputted from the fiber laser apparatus 10 as outputted laser light.

The outputted laser light from the fiber laser apparatus 10 is fed into the guide optical fiber 20 from one end thereof and propagates through the guide optical fiber 20. The outputted laser light having propagated through the guide optical fiber 20 is collimated (outputted as parallel light into the space) by the collimator 21 provided at the other end of the guide optical fiber 20. The parallel light outputted from the collimator 21 is expanded by the beam expander 31 in terms of the luminous flux diameter, and then is converged by the condenser lens 32. Thus converged outputted laser light irradiates the solder 93 set between the objects (substrate 91 and coaxial cable center conductors 92) to be soldered.

FIG. 1B is a view showing a state of arrangements of copper patterns 91a provided on a substrate 91 and the coaxial cable center conductors 92 arranged with intervals P, and a spot S of the outputted laser light. Specifically, the example shown in FIG. 1B illustrates a state in which the width of each copper line pattern 91a (the width of the electrode pad part) formed on the substrate 91 is 100 μm, the diameter of each coaxial cable center conductor 92 is 60 μm, and cream solder is applied as the solder 93 between the copper patterns on the substrate 91 and the coaxial cable center conductors 92. The laser soldering apparatus 1 scans the spot S over the substrate 91 such that the solder 93 is irradiated with the outputted laser light, so as to solder the coaxial cable center conductors 92 to the copper patterns 91a of the substrate 91, respectively.

At the time of soldering, the single-mode light (outputted laser light) outputted from the fiber laser apparatus 10 is light having a pulse width of a microsecond or greater or continuous light, and the outputted laser light from the spatial optical system 30 irradiates the objects (substrate 91 and coaxial cable center conductors 92) to be soldered or solder 93. Since the fiber laser apparatus 10 outputs single-mode light or the luminous flux diameter of the light outputted from the fiber laser apparatus 10 is expanded by the spatial optical system 30 before the light is converged, the spot diameter of the light converged by the spatial optical system 30 can become smaller.

Suppose a case where light having a wavelength λ of 1064 nm outputted from the fiber laser apparatus 10 expands its luminous flux diameter D to 10 mm with the beam expander 31 and then is converged by the condenser lens 32 having a focal length f of 100 mm. Let a be the beam quality factor (M²) of light outputted from the guide optical fiber 20. Here, the minimal spot diameter d of the light converged by the condenser lens 32 is obtained by the expression of d=1.27·f·λ·a/D. In general, the beam quality factor a of light outputted from an optical fiber is said to be 1.

Therefore, the minimal spot diameter d of the light converged by the condenser lens 32 is about 13.5 μm. Thus, the fiber laser apparatus 10 can converge laser light to minute areas and consequently perform microsize soldering, whereby the coaxial cable center conductor 92 having a diameter of 60 μm can be soldered to the copper pattern 91a having a width of 100 μm formed on the substrate 91.

In general, the spot diameter D of the light incident on the condenser lens 32 is adjusted such that the spot diameter d of the light converged by the condenser lens 32 becomes 1 μm to 100 μm. When the spot diameter d of the light converged by the condenser lens 32 is less than 1 μm, the optical system is not easy to adjust, whereby the soldering operation becomes troublesome. When the spot diameter d of the light converged by the condenser lens 32 exceeds 100 μm, on the other hand, unnecessary solder parts increase. When the spot diameter d of the light converged by the condenser lens 32 falls within the range of 1 μm to 100 μm, the soldering operation becomes easy while unnecessary solder parts are less.

When a converging point of light having a pulse width of not shorter than a microsecond or continuous light is positioned at the objects (substrate 91 and coaxial cable center conductors 92) to be soldered or solder 93, the objects (substrate 91 and coaxial cable center conductors 92) to be soldered or solder 93 can be heated without dissipating the solder 93. In this case, the substrate 91 and coaxial cable center conductors 92 can be soldered to each other in a short time (see FIGS. 1A and 1B).

Before soldering, the objects (substrate 91 and coaxial cable center conductors 92) to be soldered may be irradiated with the outputted laser light from the spatial optical system 30. This preheats the objects to be soldered, and improves attachment of solder 93 when the solder 93 is irradiated with the outputted laser light from the spatial optical system 30 (see FIGS. 1A and 1B).

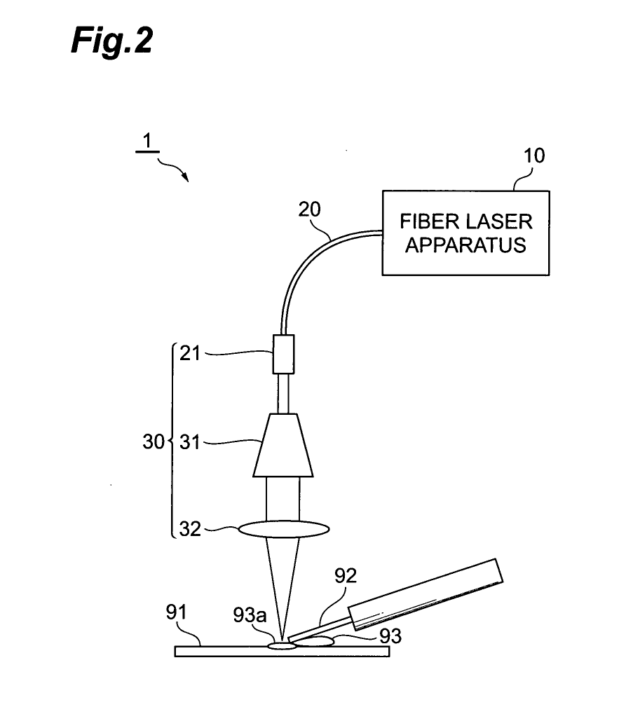

An unnecessary solder part 93a may occur at the time of soldering. It will be preferred in this case if light having a pulse width of a nanosecond or less outputted as outputted laser light from the fiber laser apparatus 10 (or another fiber laser apparatus) irradiates the unnecessary solder part 93a through the spatial optical system 30. This can favorably remove the unnecessary solder part 93a (see FIG. 2).

Here, it will be preferred if the pulse width of the outputted laser light irradiating the unnecessary solder part 93a is a nanosecond or less. When the irradiation power of irradiating outputted laser light per unit time is made greater, the unnecessary solder part 93a is rapidly heated without a lapse of time in which heat generated by light absorption is conducted. Such ablation can easily remove the unnecessary solder part 93a.

Light having a pulse width of a nanosecond or less can be outputted as the outputted laser light, in the case that the modulation period of a driving signal supplied to a semiconductor laser device acting as the seed light source 12 is adjusted. Light having a pulse width of a nanosecond or less can also be outputted, in the case that a pulse compressor which compresses the pulse width is provided.

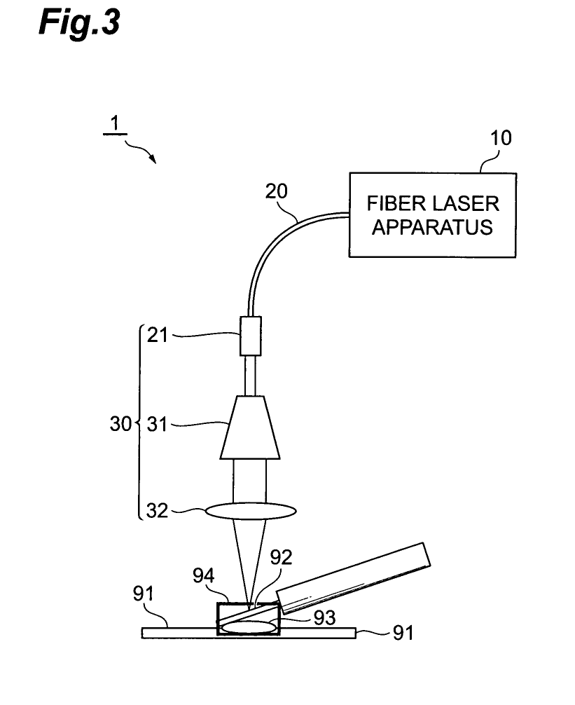

It will also be preferred when the coaxial cable center conductors 92 are bonded to the surface of a plastic sheet with an adhesive, and are soldered to the substrate 91 in the state where the coaxial cable center conductors 92 bonded to the plastic sheet are in contact with the substrate 91. Alternatively, after soldering the coaxial cable center conductors 92 and the substrate 91 to each other, the soldering parts of the coaxial cable center conductors 92 and substrate 91 may be covered with a plastic sheet 94, and the outputted laser light (light having a pulse width of not shorter than a microsecond or continuous light) from the fiber laser apparatus 10 may irradiate the plastic sheet 94 from the upper side through the spatial optical system 30. In this case, the plastic sheet 94 covering the soldering parts forms a protective film (see FIG. 3). Namely, the soldering parts in the coaxial cable center conductors 92 and substrate 91 are covered with the plastic protective film. As the plastic sheet 94, polyacetal, polycarbonate, or polyethylene terephthalate is used favorably, for example.

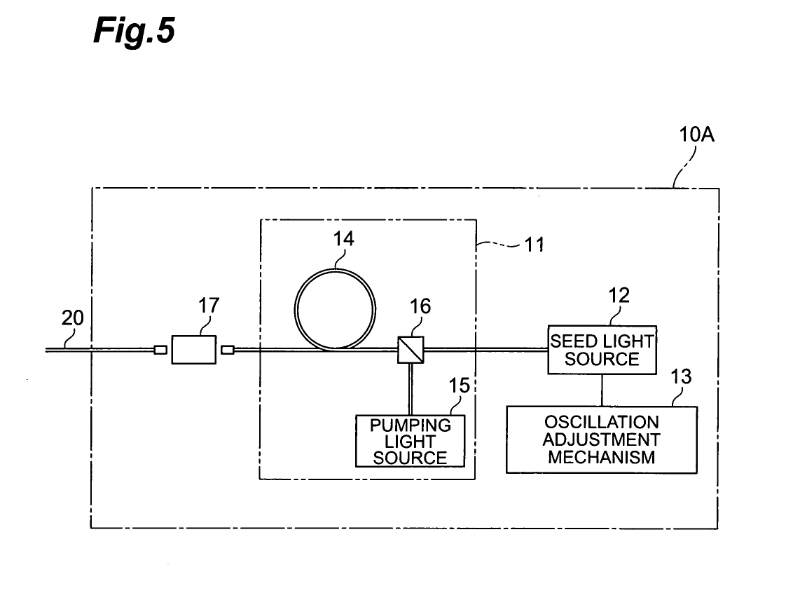

FIG. 5 is a view showing another structure of the fiber laser apparatus 10 employable in the laser soldering apparatus according to the present invention. The fiber laser apparatus 10A shown in FIG. 5 is employed in place of the fiber laser apparatus 10 (FIG. 4) included in the laser soldering apparatus 1 shown in FIGS. 1A, 2, and 3. The fiber laser apparatus 10A shown in FIG. 5 differs from the fiber laser apparatus 10 shown in FIG. 4 in that it further comprises a wavelength conversion device 17.

The wavelength conversion device 17 is an optical device which inputs light having a wavelength of 1064 nm from a Yb-doped optical fiber acting as the amplification optical fiber 14 and generates light with a wavelength of 532 nm having an optical frequency which is twice that of the former light. As such a wavelength conversion device 17, a nonlinear optical crystal such as KTP, for example, is favorably used. The light having the wavelength of 532 nm outputted from the wavelength conversion device 17 is converged on the objects (substrate 91 and coaxial cable center conductors 92) to be soldered or solder 93 through the guide optical fiber 20 and spatial optical system 30.

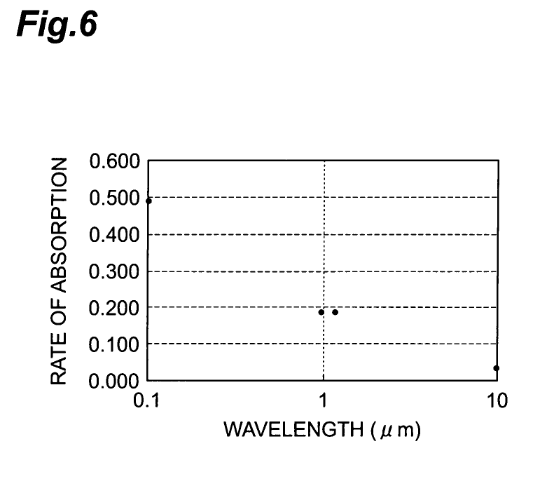

Thus irradiating the objects (substrate 91 and coaxial cable center conductors 92) to be soldered or solder 93 with the light having the wavelength of 532 nm enables soldering of further smaller areas. In general, the light absorption ratio of metals is greater at the wavelength of 532 nm than at the wavelength of 1064 nm. For example, as FIG. 6 shows the wavelength dependency of absorption ratio of Sn, the light absorption ratio of Sn at the wavelength of 532 nm is several times that at the wavelength of 1064 nm. Therefore, soldering can be performed more efficiently when the light at the wavelength of 532 nm is utilized.

The soldering method and laser soldering apparatus according to the present invention enables soldering of objects having a size further smaller than before.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A soldering method of soldering objects to each other by irradiating solder set between the objects with laser light, said method comprising the steps of:
preparing a fiber laser apparatus including an optical fiber which has a single core structure and which outputs single-mode light, and a seed light source supplying seed light to said optical fiber;
preparing a spatial optical system for converging outputted laser light from said fiber laser apparatus after collimating the outputted laser light;
controlling the seed light source such that said fiber laser apparatus outputs light having a pulse width of not shorter than a microsecond or continuous light as the outputted laser light; and
irradiating the solder set between the objects with the outputted laser light from said fiber laser apparatus after being converged by said spatial optical system.

2. A soldering method according to claim 1, wherein the objects are heated by irradiation with the outputted laser light from said fiber laser apparatus which is converged by said spatial optical system; and
wherein the outputted laser light from said fiber laser apparatus, converged by said spatial optical system, is applied to the solder set between the objects after the objects are heated.

3. A soldering method according to claim 1, wherein, after soldering the objects, an unnecessary solder part generated when soldering the objects is irradiated with light having a pulse width of a nanosecond or less outputted from one selected from said fiber laser apparatus and another fiber laser apparatus by way of said spatial optical system, whereby the unnecessary solder part is removed.

4. A soldering method according to claim 1, wherein said spatial optical system is adjusted so as to converge the outputted laser light from said fiber laser apparatus such that a spot size of the outputted laser light, applied to the solder from said fiber laser apparatus, falls within the range of 1 μm to 100 μm.

5. A soldering method according to claim 1, wherein said optical fiber includes a Yb-doped optical fiber, while said fiber laser apparatus includes a wavelength conversion device for converting the wavelength of the output light from said optical fiber; and
wherein the light whose wavelength is converted to 532 nm by said wavelength conversion device irradiates the solder by way of said spatial optical system.

6. A soldering method according to claim 1, wherein said seed light source includes a semiconductor laser; and
wherein said fiber laser apparatus has an oscillation adjustment mechanism adjusting an oscillation condition of said semiconductor laser as a MOPA-type laser apparatus.

7. A soldering method according to claim 1, wherein, before soldering the objects, one of the objects is bonded to a surface of a plastic sheet with an adhesive; and
while the one object bonded to said plastic sheet is in contact with the other object, the objects are soldered to each other.

8. A soldering method according to claim 1, wherein respective soldering parts of the objects are covered with a plastic sheet after soldering the objects; and
as the outputted laser light from said fiber laser apparatus, light having a pulse width of not shorter than a microsecond or continuous light is applied to said plastic sheet by way of said spatial optical system, so as to form a plastic protective film in the soldering parts.

9. A laser soldering apparatus for soldering objects to each other by irradiating solder set between the objects with laser light, said apparatus comprising:
a fiber laser apparatus outputting single-mode light as outputted laser light, said fiber laser apparatus including an optical fiber which has a single core structure and which outputs the single-mode light, a seed light source supplying seed light to said optical fiber, and an oscillation adjustment mechanism for enabling both continuous and pulsed oscillations in said optical fiber; and
a spatial optical system including a collimator collimating the outputted laser light from said fiber laser apparatus, and a condenser lens converging the outputted laser light having transmitted through said collimator,
wherein said fiber laser apparatus outputs light having a pulse width of not shorter than a microsecond or continuous light as the outputted laser light.

10. A laser soldering apparatus according to claim 9, wherein said oscillation adjustment mechanism enables an oscillation of a nanosecond pulse in said optical fiber; and
wherein said fiber laser apparatus has, in order to regulate an oscillation condition in said optical fiber, a pulse width adjustment mechanism adjusting the pulse width of the outputted laser light.
